(19) United States
(12) Patent Application Publication
(10) Pub. No.: US 2024/0346126 A1
(43) Pub. Date: Oct. 17, 2024

(54) NETWORK NODE AND COMMUNICATION METHOD

(71) Applicant: NTT DOCOMO, INC., Tokyo (JP)

(72) Inventors: Yuji Suzuki, Tokyo (JP); Atsushi Minokuchi, Tokyo (JP)

(73) Assignee: NTT DOCOMO, INC., Tokyo (JP)

(21) Appl. No.: 18/682,023

(22) PCT Filed: Aug. 17, 2021
(86) PCT No.: PCT/JP2021/030085

§ 371 Date: Feb. 7, 2024

(51) Int. Cl. G06F 21/44

(52) U.S. Cl. CPC G06F 21/44

(57) ABSTRACT

This network node comprises: a reception unit that receives, from a first user, an authorization request for an Application Programming Interface (API) call, for which the authorization of a second user is required; a control unit that identifies the second user on the basis of the authorization request; and a transmission unit that transmits, to the second user, information to the effect that the authorization request has been received from the first user.

### TECHNICAL FIELD

The present disclosure relates to a network node and a communication method.

### BACKGROUND ART

In the 3rd Generation Partnership Project (3GPP), in order to realize a further increase in system capacity, a further increase in data transmission rate, a further decrease in delay in a radio section, and/or the like, a radio communication system called 5G or New Radio (NR) (hereinafter, the radio communication system is referred to as “5G” or “NR”) has been discussed. In 5G, various radio technologies have been discussed in order to satisfy the requirement that the delay of the radio section be 1 ms or less while achieving the throughputs equal to or greater than 10 Gbps.

In NR, the network architecture has been studied, which includes a 5G Core Network (5GC) corresponding to Evolved Packet Core (EPC), which is the core network in the Long Term Evolution (LTE) network architecture, and Next Generation-Radio Access Network (NG-RAN) corresponding to Evolved Universal Terrestrial Radio Access Network (E-UTRAN), which is Radio Access Network (RAN) in the LTE network architecture (see Non Patent Literature (hereinafter, referred to as NPL) 1).

Further, for example, studies have been carried on the architecture in which a Northbound interface between a Network Exposure Function (NEF) and an Application Function (AF) in the 5G system is configured by a Common API Framework (CAPIF) (hereinafter referred to as CAPIF architecture) (see NPLs 2, 3, and 4). The CAPIF is specified as a framework applicable to all Application Programming Interfaces (APIs) provided in 3GPP.

In the 3GPP core network, APIs are open for external applications, and third-party applications in the CAPIF can invoke an API and access an API exposing function. At that time, a CAPIF Core Function (CCF) in the network manages an application capable of invoking the API and then authenticates and authorizes the application that has invoked the API (API invoker).

In the CAPIF, an API invoker is authorized to invoke an API with authentication of the CCF and is enabled to access an API exposing function.

In addition, a mechanism for performing authorization other than the CAPIF includes OAuth 2.0: IETF RFC 6749, and usage of an Authorization code grant type scheme, which is specified therein, allows an authorization server (corresponding to CCF) to authorize a client (corresponding to API invoker) to access a protection resource (corresponding to API exposing function) without passing confidential information such as a password on to the client.

In the Authorization code grant type, a client (typically application on smartphone) asks a resource holder associated with the client for access to an authorization server, by performing an HTTP redirect in a Web browser. Thus, authentication information and authorization information are exchanged between the authorization server and the resource holder, that is, where the client cannot recognize.

### CITATION LIST

### Non Patent Literature

### NPL 1

3GPP TS 23.501 V17.1.1 (2021-06)

### NPL 2

3GPP TS 29.122 V17.2.0 (2021-06)

### NPL 3

3GPP TS 29.522 V17.2.0 (2021-06)

### NPL 4

3GPP TS 23.222 V17.5.0 (2021-06)

### SUMMARY OF INVENTION

As another use case, a case can be assumed where user A, which is an API invoker, invokes an API for another user B that is not associated (e.g., information on service quality or on privacy, such as quality of service (QOS) or location information). In this case, user A needs to obtain approval from user B so as to invoke the API for user B.

However, the current CAPIF is on the assumption that once an API invoker is authenticated, invocation of the API is authorized as mentioned above, so that the aforementioned use case requiring the approval from another user cannot be supported. In order to support such a use case, extension of the CAPIF is needed.

Further, in the authorization code grant type scheme, when a client is not associated with a resource holder (another user), the client cannot redirect to an authorization server. In this case, the resource holder cannot receive the redirect indication from the client, so that the authorization server cannot be aware of that the client requests access to a protection resource and cannot thus authorize the access to the protection resource.

One aspect of the present disclosure provides a network node and a communication method which allow a user to invoke an API for another user not associated after asking the other user as to whether the user can invoke the API.

A network node according to one aspect of the present disclosure includes: a reception section that receives, from a first user, an authorization request for invocation of an Application Programming Interface (API) which requires authorization from a second user; a control section that identifies the second user based on the authorization request; and a transmission section that transmits, to the second user, information indicating that the authorization request has been received from the first user.

A communication method according to one aspect of the present disclosure includes: indicating to a network node, by a first user, an authorization request for invocation of an Application Programming Interface (API) which requires authorization from a second user; identifying, by the network node, the second user based on the authorization request; transmitting to the second user, by the network node, information indicating that the authorization request has been received from the first user; verifying, by the second user, the authorization request and authorizing, by the second user, the first user; transmitting to the network node, by the second user, information indicating that the authorization has been made for the invocation of the API of the first user; issuing an access token, by the network node, based on the authorization of the second user; transmitting the access token to the first user, by the network node; and invoking, by the first user using the access token, the API which requires the authorization from the second user.

### BRIEF DESCRIPTION OF DRAWINGS

FIG. 1 is a diagram for describing an exemplary communication system;

FIG. 2 is a diagram for describing another exemplary communication system in a roaming environment;

FIG. 3 is a diagram for describing a CAPIF architecture;

FIG. 4 is a diagram for describing a sequence of CAPIF;

FIG. 5 is a diagram for describing a system configuration that uses an Authorization code grant type scheme;

FIG. 6 is a diagram for describing a sequence of the Authorization code grant type scheme;

FIG. 7 is a diagram for describing a system configuration according to an embodiment of the present disclosure;

FIG. 8 is another diagram for describing the system configuration according to the embodiment of the present disclosure;

FIG. 9 is a diagram for describing a sequence of a system according to the embodiment of the present disclosure;

FIG. 10 illustrates an exemplary functional configuration of a terminal according to the embodiment of the present disclosure;

FIG. 11 illustrates an exemplary functional configuration of a base station according to the embodiment of the present disclosure;

FIG. 12 illustrates an exemplary functional configuration of a Network Exposure Function (NEF) according to the embodiment of the present disclosure; and

FIG. 13 illustrates an exemplary hardware configuration of the terminal, the base station, or the network node according to the embodiment of the present disclosure.

### DESCRIPTION OF EMBODIMENTS

Hereinafter, an embodiment of the present disclosure will be described with reference to the accompanying drawings. Note that the embodiment to be described below is merely an example, and an embodiment to which the present disclosure is applied is not limited to the embodiment below.

The existing technology may be appropriately used for an operation of a radio communication system according to an embodiment of the present disclosure. The existing technology includes but not limited to existing LTE or existing 5G, for example.

The names of nodes, signals, etc. in the following description are from the current 5G specification (or LTE specification), but different names may be used for nodes, signals, etc. having the same functions as those in the following description.

For example, in an embodiment of the present disclosure, the terms used in the existing LTE are sometimes used, such as a synchronization signal (SS), a primary SS (PSS), a secondary SS (SSS), a physical broadcast channel (PBCH), a physical random access channel (PRACH), a physical downlink control channel (PDCCH), a physical downlink shared channel (PDSCH), a physical uplink control channel (PUCCH), and a physical uplink shared channel (PUSCH). The terms in NR corresponding to the above terms are NR-SS, NR-PSS, NR-SSS, NR-PBCH, NR-PRACH, NR-PDCCH, NR-PDSCH, NR-PUCCH, and NR-PUSCH. Note that “NR-” is not always necessary for a signal used in NR.

### (System Configuration Example A)

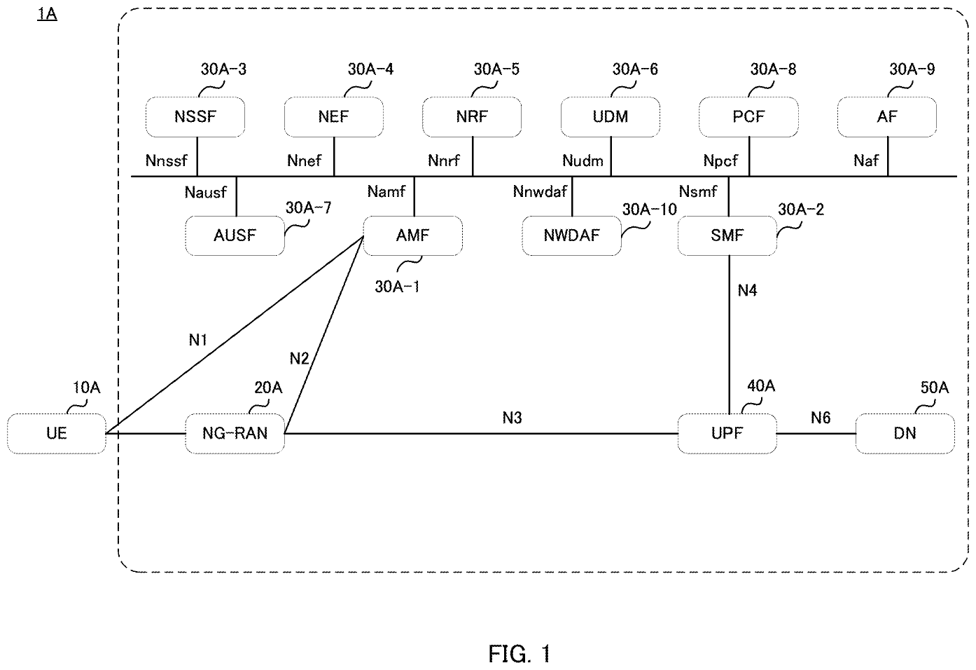

FIG. 1 is a diagram for describing an example of communication system 1A. As illustrated in FIG. 1, Communication system 1A is configured to include, for example, UE 10A (User Equipment: may be referred to as a (user) terminal or a (user) node), and a plurality of network nodes 20A, 30A-1 to 30A-10 (may be referred to as Network Function (NF)), and 40A. Hereafter, an assumption is made that one network node corresponds to each function, but one network node may realize a plurality of functions, or a plurality of network nodes may realize one function. Further, the term “connection” described below may be a logical connection or a physical connection.

Next generation-radio access network (NG-RAN) 20A is a network node having a radio access function, and may be, for example, a next generation node B (gNB or may be referred to as base station). NG-RAN 20A is connected to UE 10A, access and mobility management function (AMF) 30A-1, and user plane function (UPF) 40A.

AMF 30A-1 is a network node having functions such as RAN interface termination, non-access stratum (NAS) termination, registration management, connection management, reachability management, and mobility management. AMF 30A-1 is connected to UE 10A, NG-RAN 20A, session management function (SMF) 30A-2, network slice selection function (NSSF) 30A-3, network exposure function (NEF) 30A-4, network repository function (NRF) 30A-5, unified data management (UDM) 30A-6, authentication server function (AUSF) 30A-7, policy control function (PCF) 30A-8, application function (AF) 30A-9, and network data analytics function (NWDAF) 30A-10. Note that AMF 30A-1 may also be referred to as an access mobility management apparatus.

AMF 30A-1, SMF 30A-2, NSSF 30A-3, NEF 30A-4, NRF 30A-5, UDM 30A-6, AUSF 30A-7, PCF 30A-8, AF 30A-9, and NWDAF 30A-10 are network nodes interconnected with each other via interfaces Namf, Nsmf, Nnssf, Nnef, Nnrf, Nudm, Nausf, Npcf, Naf, and Nnwdaf, based on the respective services.

SMF 30A-2 is a network node having functions such as session management, UE Internet protocol (IP) address allocation and management, a dynamic host configuration protocol (DHCP) function, an address resolution protocol (ARP) proxy, and a roaming function. Note that SMF 30A-2 may also be referred to as a session management apparatus. NSSF 30A-3 is a network node having functions such as selecting a network slice to which a UE is connected, determining Network Slice Selection Assistance Information (NSSAI) to be permitted, determining an NSSAI to be configured, and determining an AMF set to which a UE is connected.

NEF 30A-4 is a network node having a function to indicate a capability and an event to another NF.

NRF 30A-5 is a network node having a function to discover an NF instance for providing a service.

UDM 30A-6 is a network node that manages subscriber data and authentication data. UDM 30A-6 is connected to a user data repository (UDR) that holds the data.

AUSF 30A-7 is a network node that authenticates a subscriber/UE 10A for the subscriber data held in the UDR.

PCF 30A-8 is a network node having a function to perform network policy control.

AF 30A-9 is a network node having a function to control an application server.

NWDAF 30A-10 is a network node that collects and analyzes data acquired by the network to provide the analysis result.

UPF 40A is a network node having functions such as an external protocol data unit (PDU) session point interconnecting to NG-RAN 20A and data network (DN) 50A, packet routing and forwarding, and quality of service (QOS) handling for user plane, and transmits and receives user data. Note that UPF 40A may also be referred to as a user plane apparatus.

For example, a certain UPF 40A and DN 50A may configure a network slice. In the radio communication network according to an embodiment of the present disclosure, a plurality of network slices is constructed. Note that a single UPF 40A may operate a single network slice, or a single UPF 40A may operate a plurality of network slices.

Further, UPF 40A is physically, for example, one or more computers (servers and the like). A plurality of resources obtained by logically integrating/dividing hardware resources (CPU, memory, hard disk, network interface, and the like) of the computer can be regarded as a resource pool, and UPF 40A can use each resource in the resource pool as a network slice. The operation of the network slice by UPF 40A is, for example, to manage the association between the network slice and the resource, to start and stop the resource, to monitor the operation status of the resource, and the like.

### (System Configuration Example B)

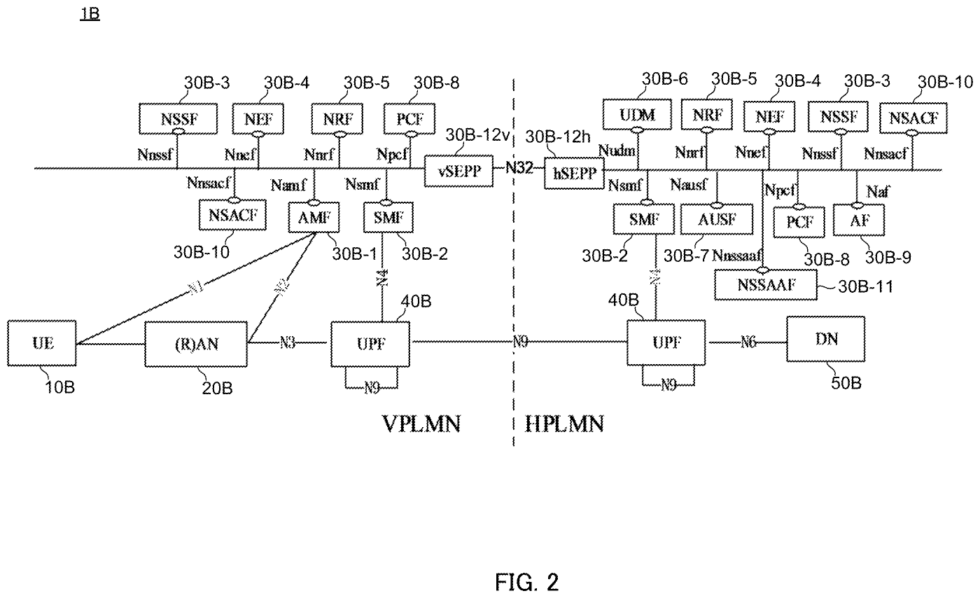

FIG. 2 is a diagram for describing an example of communication system 1B in a roaming environment. As illustrated FIG. 2, communication system 1B is configured to include, for example, UE 10B, which is a communication terminal (node) used by a user, and a plurality of network nodes 20B, 30B-1 to 30B-12, and 40B.

Communication system 1B is a system included in a 5G network system, and is a system that provides a network service to UE 10B by data communication. The term “network service” refers to a service using network resources, such as a communication service (e.g., leased line service) and/or an application service (e.g., video streaming, and/or service using sensor device, such as embedded device).

In FIG. 2, it is assumed that UE 10B is in the roaming environment. The expression “UE 10B is in the roaming environment” means a state in which communication is performed by accessing a Visited Public Land Mobile Network (VPLMN), which is a network other than Home Public Land Mobile Network (HPLMN). The term VPLMN refers to a network where UE 10B is currently present (currently present network), and the term HPLMN refers to a network provided by a subscribed carrier of the user of UE 10B. VPLMN of communication system 1B is formed of UE 10B, (Radio) Access

Network ((R) AN) 20B, Access and Mobility Management Function (AMF) 30B-1, Session Management function (SMF) 30B-2, Network Slice Selection Function (NSSF) 30B-3, Network Exposure Function (NEF) 30B-4, Network Repository Function (NRF) 30B-5, Policy Control Function (PCF) 30B-8, Network Slice Admission Control Function (NSACF) 30B-10, Security Edge Protection Proxy (SEPP) 30B-12, and User Plane Function (UPF) 40B.

HPLMN of communication system 1B is formed of SMF 30B-2, NSSF 30B-3, NEF 30B-4, NRF 30B-5, Unified Data Management (UDM) 30B-6, Authentication Server Function (AUSF) 30B-7, PCF 30B-8, Application Function (AF) 30B-9, NSACF 30B-10, Network Slice Specific Authentication and Authorization Function (NSSAAF) 30B-11, SEPP 30B-12, and UPF 40B.

(R) AN 20B is a network node having a radio access function and may be, for example, a next generation Node B (gNB) (may be referred to as base station).

AMF 30B-1 is a network node having functions such as RAN interface termination, non-access stratum (NAS) termination, registration management, connection management, reachability management, and mobility management.

SMF 30B-2 is a network node having functions such as session management, UE Internet protocol (IP) address allocation and management, a dynamic host configuration protocol (DHCP) function, an address resolution protocol (ARP) proxy, and a roaming function.

NSSF 30B-3 is a network node having functions such as selecting a network slice to which a UE is connected, determining Network Slice Selection Assistance Information (NSSAI) to be permitted, determining an NSSAI to be configured, and determining an AMF set to which a UE is connected.

NEF 30B-4 is a network node having a function to indicate a capability and an event to another NF.

NRF 30B-5 is a network node having a function to discover an NF instance for providing a service.

UDM 30B-6 is a network node that manages subscriber data and authentication data. UDM 30B-6 is connected to a user data repository (UDR) that holds the data.

AUSF 30B-7 is a network node that authenticates a subscriber/UE 10B for the subscriber data held in the UDR.

PCF 30B-8 is a network node having a function to perform network policy control.

AF 30B-9 is a network node having a function to control an application server.

NSACF 30B-10B is a network node having a function to control approval of a network slice.

NSSAAF 30B-11 is a network node having a function to control authentication/authorization of a network slice.

SEPP 30B-12 is a network node having a proxy to control filtering and policy restriction of a message during interaction of control plane between carriers. Incidentally, SEPP 30B-12 on a VPLMN side is referred to as vSEPPB 30B-12v, and SEPP 30B-12 on an HPLMN side is referred to as hSEPP 30B-12h. Herein, vSEPP 30B-12v and hSEPP 30B-12h provide functions on security and integrity for messages (such as HTTP Request and HTTP Response) transmitted and received between VPLMN and HPLMN.

UPF 40B is a network node having functions such as an external Protocol Data Unit (PDU) session point, routing and forwarding of packets, and Quality of Service (QOS) handling for user plane.

Incidentally, N1, N2, N3, N4, and N9 are each a reference point between network nodes. Further, N32 between vSEPP 30B-12v and hSEPP 30B-12h is a reference point for the connection point between VPLMN and HPLMN.

(R) AN 20B is connected to UE 10B, AMF 30B-1, and UPF 40B.

In VPLMN, AMF 30B-1, SMF 30B-2, NSSF 30B-3, NEF 30B-4, NRF 30B-5, PCF 30B-8, and NSACF 30B-10 are interconnected with each other via interfaces Namf, Nsmf, Nnssf, Nnef, Nnrf, Npcf, and Nsacf, based on the respective services.

In HPLMN, SMF 30B-2, NSSF 30B-3, NEF 30B-4, NRF 30B-5, UDM 30B-6, AUSF 30B-7, PCF 30B-8, AF 30B-9, NSACF 30B-10, and NSSAAF 30B-11 are interconnected with each other via interfaces Nsmf, Nnssf, Nnef, Nnrf, Nudm, Nausf, Npcf, Naf, and Nsacf, and Nnssaaf, based on the respective services.

vSEPP 30B-12v is connected to AMF 30B-1, SMF 3B0-2, NSSF 30B-3, NEF 30B-4, NRF 30B-5, PCF 30B-8, and NSACF 30B-10 of VPLMN and is connected to hSEPP 30B-12h via N32.

hSEPP 30B-12h is connected to SMF 30B-2, NSSF 30B-3, NEF 30B-4, NRF 30B-5, UDM 30B-6, AUSF 30B-7, PCF 30B-8, AF 30B-9, NSACF 30B-10, and NSSAAF 30B-11 of HPLMN and is connected to vSEPP 30B-12v via N32.

UPF 40B on a VPLMN side interconnects with (R) AN 20B, SMF 30B-2, and UPF 40B on an HPLMN side. UPF 40B of HPLMN interconnects with SMF 30B-2 and Data Network (DN) 50B.

### (CAPIF Architecture)

It has been discussed that NEF30A-4 (30B-4) mentioned above implements an API that can be invoked from AF30A-9 (30B-9), by applying a CAPIF architecture. The CAPIF architecture provides a mechanism that supports service API operation, and, for example, enables an invoker of the API (API invoker) to find a service API provided by a provider of the API (API provider), thereby allowing communication using the service API. The CAPIF architecture has also, for example, a mechanism that hides a connection form (topology) of a PLMN trust domain from an API invoker accessing the service API from outside the PLMN trust domain.

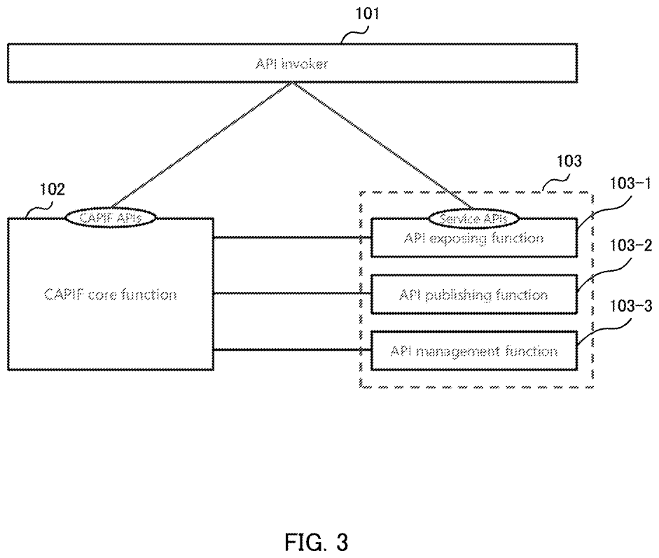

Next, the CAPIF architecture will be described with reference to FIG. 3. As illustrated in FIG. 3, the CAPIF is formed of API invoker 101, CCF 102, and API provider domain 103.

API invoker 101 is an application from which an API is invoked. API invoker 101 is connectable to CCF 102 and API provider domain 103 and is registered (onboarding) in CCF 102 in advance. Note that API invoker 101 may be a third-party application or may be an application operated by the same carrier that provides CCF 102 or API provider domain 103.

Meanwhile, a security method is agreed between API invoker 101 and CCF 102. Note that a Client Credential scheme specified in OAuth 2.0 is used for this security method. In this scheme, the API invocation is authorized by authentication from the client (API invoker) alone.

Once being authenticated and authorized by CCF 102, API invoker 101 can invoke an API and access API exposing function 103-1.

CCF 102 is a network node and manages an application capable of invoking an API. Upon receiving an authorization request for the API invocation from API invoker 101, CCF 102 performs verification of the authorization request and authenticates/authorizes API invoker 101.

API provider domain 103 has functions of API exposing function 103-1, API publishing function 103-2, and API management function 103-3. API provider domain 103 authenticates and authorizes access from API invoker 101, using API exposing function 103-1. Moreover, API provider domain 103 publishes a Service API on CCF 102, using API publishing function 103-2. Further, API provider domain 103 audits a log of the API invocation received from CCF 102 and monitors a state of the Service API, using API management function 103-3.

### (CAPIF Sequence)

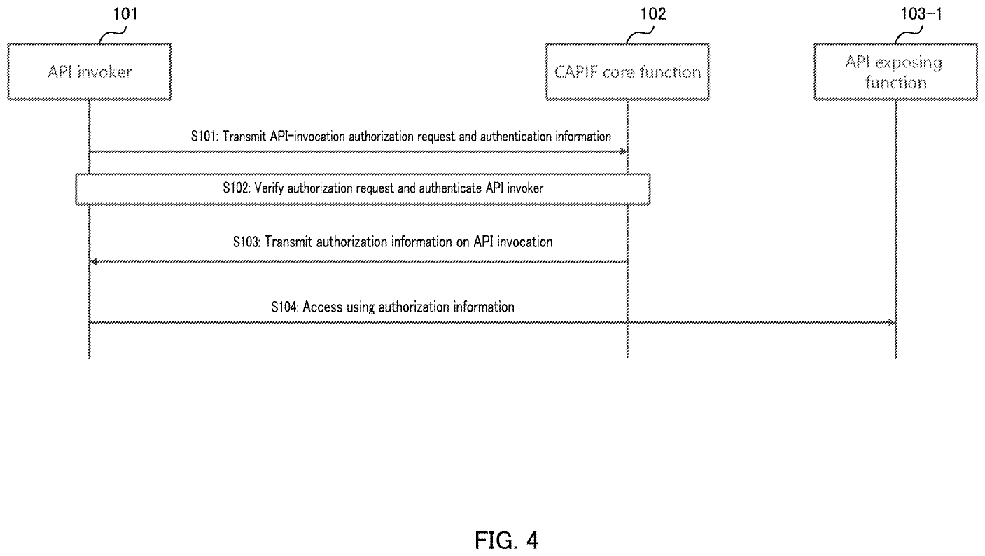

Next, a sequence of the CAPIF, that is, the sequence until API invoker 101 performs API invocation will be described with reference to FIG. 4. Note that, it is assumed that API invoker 101 is registered (onboarding) in CCF 102 in advance and the security method is agreed between API invoker 101 and CCF 102.

First, in S101, API invoker 101 transmits, to CCF 102, an authorization request for API invocation. In this case, API invoker 101 transmits, to CCF 102, authentication information together.

In S102, CCF 102 verifies the authorization request from API invoker 101 and performs authentication processing for API invoker 101.

Upon completion of the authentication processing, in S103, CCF 102 transmits authorization information on the API invocation, specifically an access token.

In S104, API invoker 101 performs the API invocation with the authorization information (access token) and then accesses API exposing function 103-1.

### (System Configuration of Authorization Code Grant Type Scheme)

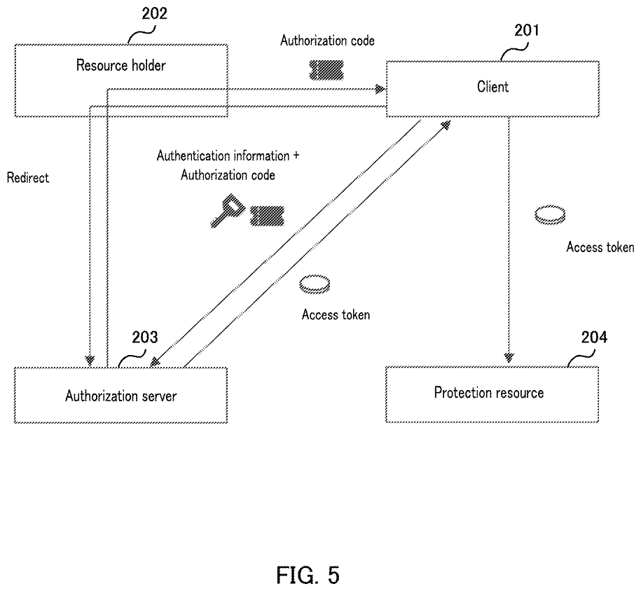

Next, a configuration of a system using the Authorization code grant type scheme specified in OAuth 2.0 will be described with reference to FIG. 5. Note that the Authorization code grant scheme is generally used for Social Networking Service (SNS) linkage and the like of smartphone applications.

As illustrated in FIG. 5, the Authorization code grant type scheme is used for a system composed of client 201, resource holder 202, authorization server 203, and protection resource 204.

Client 201 corresponds to API invoker 101 of the CAPIF and is, for example, a third-party-service application linkable with an SNS, typically an application on a smartphone.

Client 201 asks resource holder 202 associated with client 201 for access to authorization server 203, by performing an HTTP redirect in a Web browser.

Upon receiving an authorization code from authorization server 203 via resource holder 202, client 201 requests issuance of an access token by transmitting authentication information and the authorization code to authorization server 203, thus receiving the access token from authorization server 203. Client 201 accesses protection resource 204, using the access token.

Resource holder 202 is, for example, a user that owns an SNS account or a terminal owned by the user. Upon being redirected from client 201, resource holder 202 transmits authentication from authorization server 203 and authorizes client 201 to access protection resource 204.

Authorization server 203 corresponds to CCF 102 of the CAPIF and is, for example, an SNS server. Authorization server 203 authenticates resource holder 202, redirects resource holder 202 to client 201, and transmits the authorization code to client 201.

Upon receiving a request for access token issuance from client 201, authorization server 203 verifies the request from client 201 and issues the access token to client 201 when there is no problem.

Protection resource 204 corresponds to API exposing function 103-1 of the CAPIF and is, for example, personal information in an SNS.

### (Sequence of Authorization Code Grant Type Scheme)

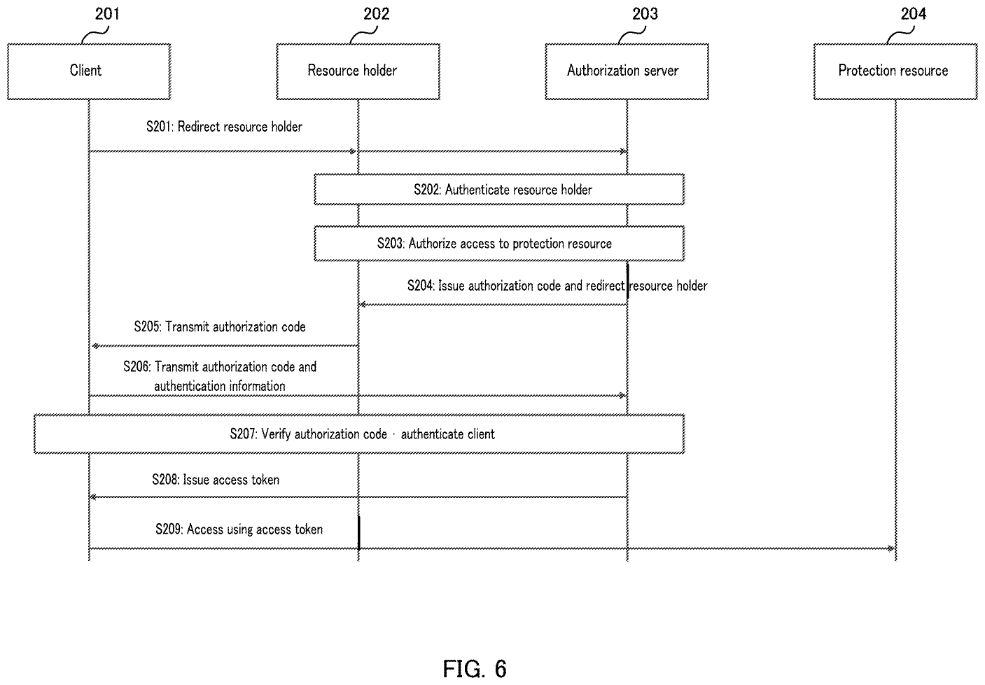

Next, a sequence of the Authorization code grant type scheme, i.e., the sequence until client 201 accesses protection resource 204 will be described with reference to FIG. 6.

First, in S201, client 201 redirects resource holder 202 to authorization server 203.

Authorization server 203 authenticates resource holder 202 in S202. Meanwhile, in S203, resource holder 202 authorizes client 201 to access protection resource 204.

Next, in S204, authorization server 203 issues an authorization code and redirects resource holder 202 to client 201. Upon receiving the redirect, in S205, resource holder 202 transmits the authorization code to client 201.

In S206, client 201 then requests authorization server 203 to issue an access token, by transmitting the authorization code and authentication information on client 201 itself to authorization server 203.

Authorization server 203 verifies the authorization code for the request from the client and authenticates client 201 when there is no problem in S207, and issues the access token to client 201 in S208.

In S209, client 201 accesses protection resource 204 with the access token.

### (Configuration of New System)

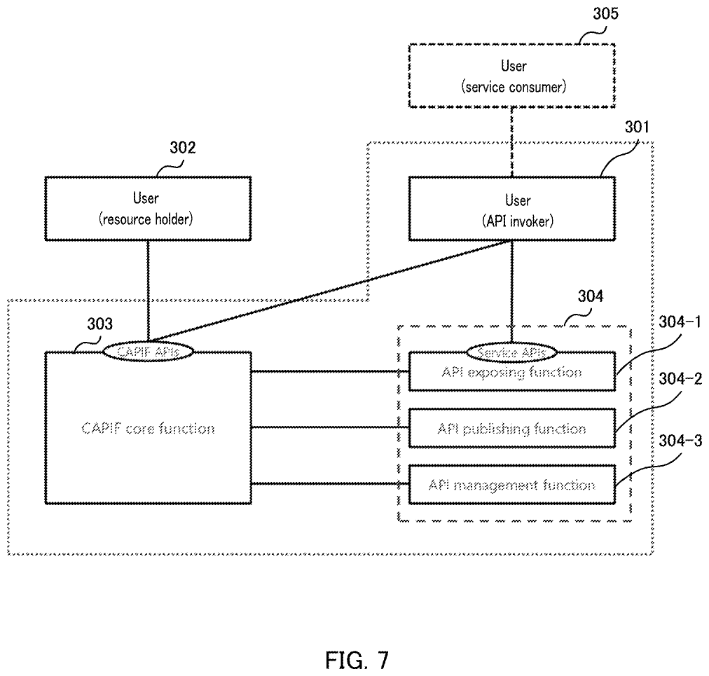

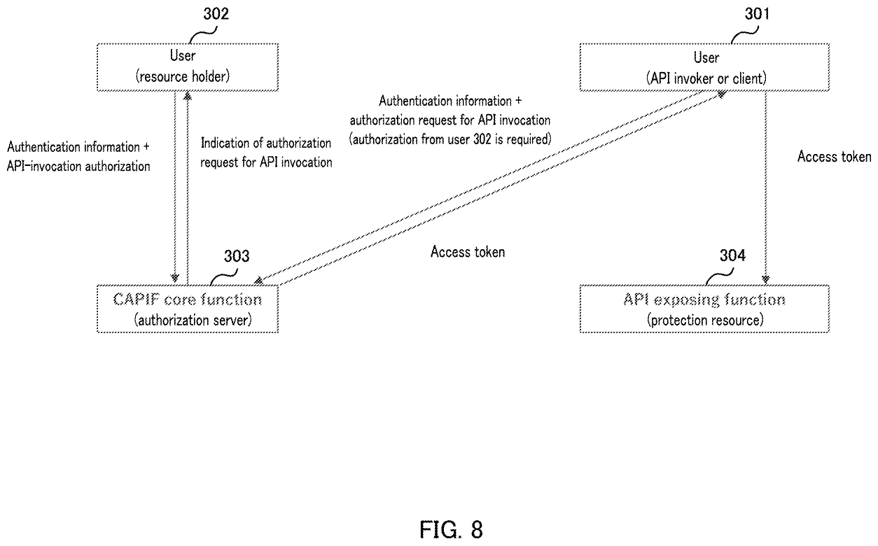

Next, a description will be given with reference to FIGS. 7 and 8 of a configuration of a system that is newly proposed in the present application and is obtained by extending the CAPIF. Incidentally, FIG. 8 illustrates the system illustrated in FIG. 7 from another viewpoint.

As illustrated in FIGS. 7 and 8, the newly proposed system composed of user 301, user 302, CCF 303, and API provider domain 304. In the present embodiment, user 301 is a first user node and user 302 is a second user node.

User 301 may be, for example, a user of a terminal such as a smartphone or a terminal (node) owned by the user, and may be an API invoker or a client. User 301 may be an application server operated by a service carrier. In this case, the application server may be used by another user 305, which is a service consumer, and a request from user 305 may be trigger a request for authorization of API invocation. In the present system, user 305 is optional, so that user 305 is illustrated in dotted lines in FIG. 7.

User 301 is connectable to CCF 303 and API provider domain 304 and is registered (onboarding) in CCF 303 in advance. Note that user 301 and user 302 are not associated with each other.

User 301 transmits, to CCF 303, authentication information on user 301 itself while transmitting, to CCF 303, an authorization request for invocation of an API that requires authorization from user 302. Upon indicated by CCF 303 that user 302 has given authorization, and reception of an access token, user 301 invokes API provider domain 304 with the access token and then accesses API exposing function 304-1. This allows user 301 to invoke an API that requires the authorization from user 302.

User 302 is a resource holder or a terminal (node) owned by the resource holder, and is connectable to CCF 303.

Upon receiving, from CCF 303, the indication that the authorization request for the API invocation has been received from user 301, user 302 verifies the authorization request. When authorizing user 301, as a result of the verification, user 302 transmits authentication information on user 302 itself to CCF 303. Upon being authenticated by CCF 303, user 302 transmits, to CCF 303, information indicating that the API invocation of user 301 is authorized.

CCF 303 is a network node and manages an application capable of invoking an API. Upon receiving, from user 301, the authorization request for the invocation of the API that requires the authorization from user 302, together with the authentication information, CCF 303 verifies the authorization request and authenticates user 301. Further, CCF 303 identifies, based on the authorization request from user 301, user 302 from which the approval (authorization) is to be acquired and then indicates that, to user 302, the authorization request for the API invocation has been received from user 301.

Furthermore, CCF 303 authenticates user 302 upon receiving the authentication information from user 302. Additionally, upon being indicated by user 302 authorization of the API invocation of user 301, CCF 303 issues an access token to user 301.

In the present embodiment, there is no particular limitation on a method of authentication performed by CCF 303, and thus, authentication by a password, key exchange, or SIM information usage may be performed, for example.

API provider domain 304 has functions of API exposing function 304-1, API publishing function 304-2, and API management function 304-3. API provider domain 304 authenticates and authorizes access from user 301, using API exposing function 304-1.

Moreover, API provider domain 304 publishes a Service API on CCF 303, using API publishing function 304-2. Further, API provider domain 304 audits a log for the API invocation received from CCF 303 and monitors a state of the Service API, using API management function 304-3.

### (Sequence of New System)

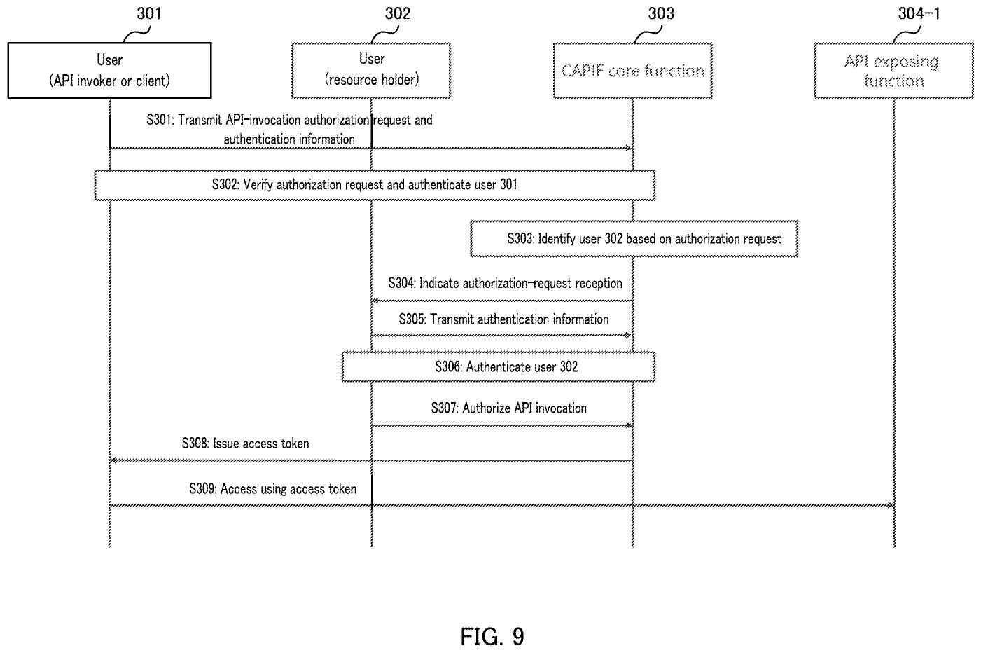

Next, a description will be given with reference to FIG. 9 of a sequence of the system newly proposed in present application, i.e., the sequence until user 301 performs invocation of an API that requires the authorization from user 302. Note that user 301 is assumed to be registered (onboarding) in CCF 303 in advance.

First, in S301, user 301 transmits, to CCF 303, an authorization request for invocation of an API that requires the authorization from user 302. In this case, user 301 transmits, to CCF 303, authentication information together.

In S302, CCF 303 verifies the authorization request from user 301 and performs authentication processing for user 301.

Upon completion of the authentication processing, in S303, CCF 303 identifies, based on the authorization request from user 301, user 302 from which the authorization is to be acquired and, in S304, indicates, to user 302, that the authorization request for the API invocation has been received from user 301.

In S305, user 302 transmits authentication information to CCF 303. In S306, CCF 303 performs authentication processing for user 302.

In S307, user 302 authorizes the API invocation of user 301 and then transmits, to CCF 303, information indicating that the authorization has been made.

In S308, CCF 303 issues an access token indicating that the authorization has been made by user 302 and then transmits the access token to user 301.

In S309, user 301 performs the API invocation with the access token and then accesses API exposing function 304-1.

### Effects

In this manner described above, according to the present embodiment, a CCF identifies user 302 (resource holder) based on an authorization request from user 301 for invocation of an API that requires authorization from user 302, thereby making it possible to acquire authorization from the other user while eliminating the need for redirection.

This allows authorization to be granted from another user for API usage so that an unintended user and a malicious user do not change the quality of service of other users without permission or steal information on privacy. As long as the authorization from another user is obtained, a service carrier can change the quality of service of a particular user group, such as uniformly improving the communication quality of participants in a certain competition, thereby improving the convenience of the API usage.

### (Apparatus Configuration)

Next, descriptions will be given of exemplary functional configurations of terminal 10, base station 20, and NEF 30A-4 (30B-4), which perform the processing and operations described above. Although terminal 10, base station 20, and NEF 30A-4 (30B-4) include the functions described in the above examples, terminal 10, base station 20, and NEF 30A-4 (30B-4) may include only some of the functions described in the above examples.

### <Terminal 10>

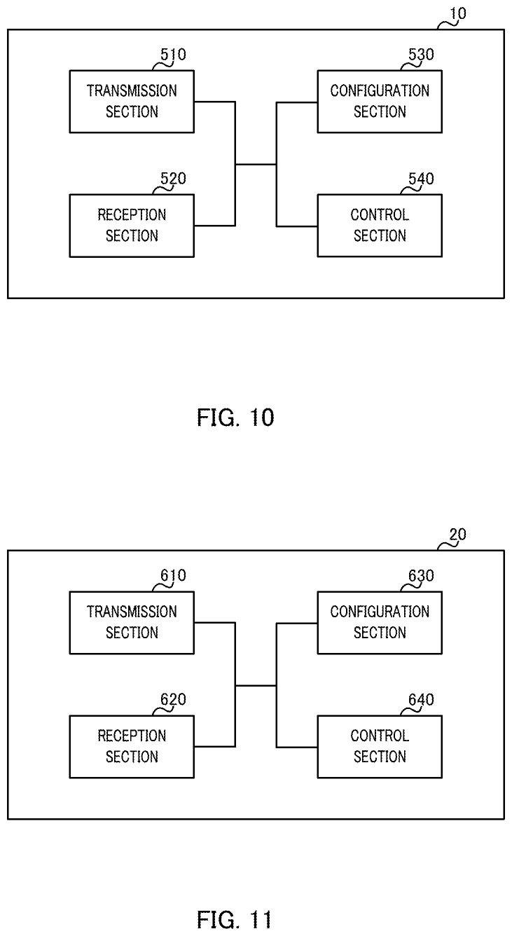

FIG. 10 illustrates an exemplary functional configuration of terminal 10 according to an embodiment of the present disclosure. As illustrated in FIG. 10, terminal 10 includes transmission section 510, reception section 520, configuration section 530, and control section 540. The functional configuration illustrated in FIG. 10 is merely an example. Any names may be used for the function categories and function sections as long as they are capable of performing an operation according to an embodiment of the present disclosure.

Transmission section 510 generates a transmission signal from transmission data, and transmits the generated transmission signal by radio. Reception section 520 receives various types of signals by radio, and acquires a higher layer signal from the received physical layer signal. Further, reception section 520 has a function of receiving an NR-PSS, NR-SSS, NR-PBCH, DL/UL/SL control signal, etc. transmitted from base station 20. As D2D communication, for example, transmission section 510 transmits a physical sidelink control channel (PSCCH), physical sidelink shared channel (PSSCH), physical sidelink discovery channel (PSDCH), physical sidelink broadcast channel (PSBCH), etc. to another terminal 10, and reception section 520 receives a PSCCH, PSSCH, PSDCH, PSBCH, etc. from another terminal 10.

Configuration section 530 stores, in a storage device (storage section), various types of configuration information received from base station 20 by reception section 520, and reads the configuration information from the storage device as needed. Configuration section 530 also stores preconfigured information configured in advance in the storage device. Contents of the configuration information and preconfigured information may include, for example, information related to a PDU session and the like. Note that configuration section 530 may be included in control section 540.

Control section 540 controls the entire terminal 10. In particular, control section 540 performs control over communication by a PDU session or the like, as described in the above examples. A function section for signal transmission in control section 540 may be included in transmission section 510, and a function section for signal reception in control section 540 may be included in reception section 520.

### <Base Station 20>

FIG. 11 illustrates an exemplary functional configuration of base station 20 according to an embodiment of the present disclosure. As illustrated in FIG. 11, base station 20 includes transmission section 610, reception section 620, configuration section 630, and control section 640. The functional configuration illustrated in FIG. 11 is merely an example. Any names may be used for the function categories and function sections as long as they are capable of performing an operation according to an embodiment of the present disclosure.

Transmission section 610 includes a function to generate a signal to be transmitted to terminal 10 and to transmit the generated signal by radio. In addition, transmission section 610 transmits an inter-network node message to another network node. Transmission section 610 also transmits as needed, to DN 50, user data transmitted by terminal 10. Reception section 620 includes a function to receive various types of signals transmitted from terminal 10 and to acquire, for example, higher layer information from the received signals. Transmission section 610 also has a function to transmit an NRPSS, NR-SSS, NR-PBCH, DL/UL control signal, etc. to terminal 10. Reception section 620 receives an inter-network node message from another network node.

Configuration section 630 stores, in a storage device (storage section), preconfigured information configured in advance and various types of configuration information to be transmitted to terminal 10, and reads the preconfigured information and configuration information from the storage device as needed. Contents of the preconfigured information and configuration information may include, for example, node connection information, information related to a PDU session, and the like. Note that configuration section 630 may be included in control section 640.

Control section 640 controls the entire base station 20. In particular, control section 640 performs control over communication by a PDU session or the like (especially, transmission, to DN 50, of user data transmitted from terminal 10, based on an indication from another network node). Control section 640 also controls communication with terminal 10 based on a UE capability report on a radio parameter received from terminal 10. A function section for signal transmission in control section 640 may be included in transmission section 610, and a function section for signal reception in control section 640 may be included in reception section 620.

### <NEF Configuration>

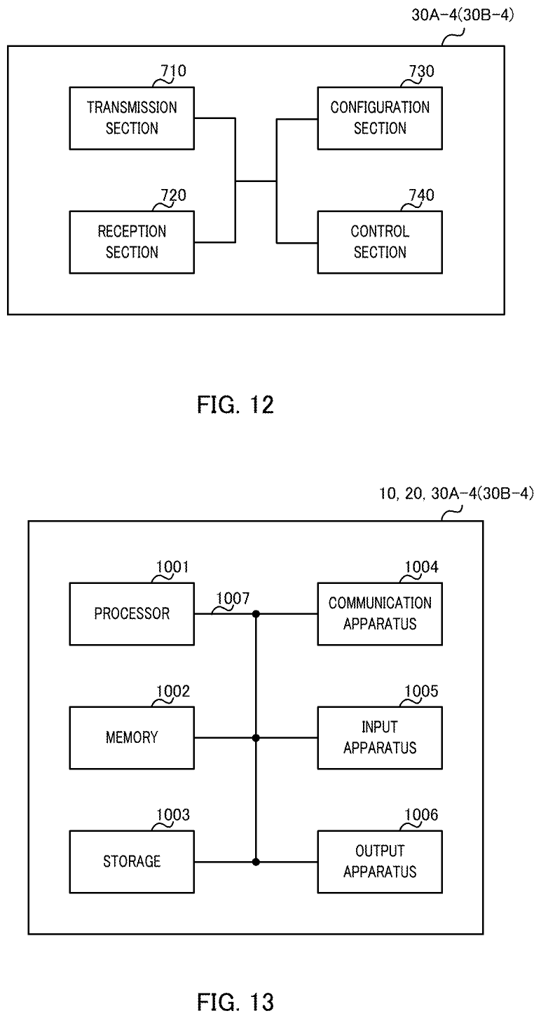

FIG. 12 illustrates an exemplary functional configuration of NEF 30A-4 (30B-4) according to an embodiment of the present disclosure. As illustrated in FIG. 12, NEF 30A-4 (30B-4) includes transmission section 710, reception section 720, configuration section 730, and control section 740. The functional configuration illustrated in FIG. 12 is merely an example. Any names may be used for the function categories and function sections as long as they are capable of performing an operation according to an embodiment of the present disclosure.

Transmission section 710 includes a function to generate a signal to be transmitted and to transmit the generated signal to a network. Reception section 720 includes a function to receive various types of signals and to acquire, for example, higher layer information from the received signals.

Configuration section 730 stores, in a storage device (storage section), preconfigured information configured in advance and configuration information, and reads the preconfigured information and configuration information from the storage device as needed. Note that configuration section 730 may be included in control section 740.

Control section 740 controls the entire NEF 30A-4 (30B-4). A function section for signal transmission in control section 740 may be included in transmission section 710, and a function section for signal reception in control section 740 may be included in reception section 720.

### (Hardware Configuration)

Note that, the block diagrams used to describe the embodiment illustrate blocks on the basis of functions. These functional blocks (component sections) are implemented by any combination of at least hardware or software. A method for implementing the functional blocks is not particularly limited. That is, the functional blocks may be implemented using one physically or logically coupled apparatus. Two or more physically or logically separate apparatuses may be directly or indirectly connected (for example, via wires or by radio), and the plurality of apparatuses may be used to implement the functional blocks. The functional blocks may be implemented by combining software with the one apparatus or the plurality of apparatuses described above.

The functions include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component section) that functions to achieve transmission is referred to as “transmitting unit,” “transmission section,” or “transmitter.” The methods for implementing the functions are not limited specifically as described above.

For example, the base station, the terminal, and the like according to an embodiment of the present disclosure may function as a computer that executes processing of a radio communication method of the present disclosure. FIG. 13 illustrates an example of hardware configuration of the terminal, the base station, or the network node according to an embodiment of the present disclosure. Terminal 10, base station 20, and NEF30A-4 (30B-4) described above may be each physically constituted as a computer apparatus including processor 1001, memory 1002, storage 1003, communication apparatus 1004, input apparatus 1005, output apparatus 1006, bus 1007, and the like.

Note that, the term “apparatus” in the following description can be replaced with a circuit, a device, a unit, or the like. The hardware configurations of terminal 10, base station 20, and NEF30A-4 (30B-4) may include one apparatus or a plurality of apparatuses illustrated in the drawings, or may not include part of the apparatuses.

The functions of terminal 10, base station 20, and NEF30A-4 (30B-4) are implemented by predetermined software (program) loaded into hardware such as processor 1001, memory 1002, and the like, according to which processor 1001 performs the arithmetic and controls communication performed by communication apparatus 1004 or at least one of reading and writing of data in memory 1002 and storage 1003.

Processor 1001 operates an operating system to entirely control the computer, for example. Processor 1001 may be composed of a central processing unit (CPU) including an interface with peripheral apparatuses, control apparatus, arithmetic apparatus, register, and the like. For example, control section 540, control section 640, control section 740, and the like as described above may be implemented by processor 1001.

Processor 1001 reads a program (program code), a software module, data, and the like from at least one of storage 1003 and communication apparatus 1004 to memory 1002 and performs various types of processing according to the program (program code), the software module, the data, and the like. As the program, a program for causing the computer to perform at least a part of the operation described in the above embodiments is used. For example, control section 540 of terminal 10, control section 640 of base station 20, and control section 740 of NEF30A-4 (30B-4) may be implemented by a control program stored in memory 1002 and operated by a control program operating in processor 1001, and the other functional blocks may also be implemented in the same way. While it has been described that the various types of processing as described above are performed by one processor 1001, the various types of processing may be performed by two or more processors 1001 at the same time or in succession. Processor 1001 may be implemented using one or more chips. Note that the program may be transmitted from a network through a telecommunication line.

Memory 1002 is a computer-readable recording medium and may be composed of, for example, at least one of a Read Only Memory (ROM), an Erasable Programmable ROM (EPROM), an Electrically Erasable Programmable ROM (EEPROM), and a Random Access Memory (RAM). Memory 1002 may be called as a register, a cache, a main memory (main storage apparatus), or the like. Memory 1002 can save a program (program code), a software module, and the like that can be executed to carry out the radio communication method according to one embodiment of the present disclosure.

Storage 1003 is a computer-readable recording medium and may be composed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. Storage 1003 may also be called as an auxiliary storage apparatus. The storage medium as described above may be, for example, a database, a server, or other appropriate media including at least one of memory 1002 and storage 1003.

Communication apparatus 1004 is hardware (transmission and reception device) for communication between computers through at least one of wired and radio networks and is also called as, for example, a network device, a network controller, a network card, or a communication module. Communication apparatus 1004 may be configured to include a high frequency switch, a duplexer, a filter, a frequency synthesizer, and the like in order to achieve at least one of Frequency Division Duplex (FDD) and Time Division Duplex (TDD), for example. For example, transmission section 510, reception section 520, transmission section 610, reception section 620, transmission section 710, reception section 720, and the like described above may be realized by communication apparatus 1004.

Input apparatus 1005 is an input device (e.g., a keyboard, a mouse, a microphone, a switch, a button, or a sensor) that receives input from the outside. Output apparatus 1006 is an output device (e.g., a display, a speaker, or an LED lamp) which makes outputs to the outside. Note that input apparatus 1005 and output apparatus 1006 may be integrated (e.g., a touch panel).

The apparatuses, such as processor 1001, memory 1002, and the like are connected by bus 1007 for communication of information. Bus 1007 may be configured using a single bus or using buses different between each pair of the apparatuses.

Furthermore, terminal 10, base station 20, and NEF30A-4 (30B-4) may include hardware, such as a microprocessor, a digital signal processor (DSP), an ASIC (Application Specific Integrated Circuit), a PLD (Programmable Logic Device), and an FPGA (Field Programmable Gate Array), and the hardware may implement part or all of the functional blocks. For example, processor 1001 may be implemented using at least one of these pieces of hardware.

### (Notification of Information and Signaling)

The notification of information is not limited to the aspects or embodiments described in the present disclosure, and the information may be notified by another method. For example, the notification of information may be carried out by one or a combination of physical layer signaling (e.g., Downlink Control Information (DCI) and Uplink Control Information (UCI)), higher layer signaling (e.g., Radio Resource Control (RRC) signaling, Medium Access Control (MAC) signaling, broadcast information (Master Information Block (MIB), and System Information Block (SIB))), and other signals. The RRC signaling may be called an RRC message and may be, for example, an RRC connection setup message, an RRC connection reconfiguration message, or the like.

### (Applied System)

The aspects and embodiments described in the present disclosure may be applied to at least one of a system using Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or other appropriate systems and a next-generation system extended based on the above systems. Additionally or alternatively, a combination of two or more of the systems (e.g., a combination of at least LTE or LTE-A and 5G) may be applied.

(Processing Procedure and/or the Like)

The orders of the processing procedures, the sequences, the flow charts, and the like of the aspects and embodiments described in the present disclosure may be changed as long as there is no contradiction. For example, elements of various steps are presented in exemplary orders in the methods described in the present disclosure, and the methods are not limited to the presented specific orders.

### (Operation of Base Station)

Specific operations which are described in the present disclosure as being performed by the base station may sometimes be performed by a higher node (upper node) depending on the situation. Various operations performed for communication with a terminal in a network constituted by one network node or a plurality of network nodes including a base station can be obviously performed by at least one of the base station and a network node other than the base station (examples include, but not limited to, Mobility Management Entity (MME) or Serving Gateway (S-GW)). Although there is one network node in addition to the base station in the case illustrated above, a plurality of other network nodes may be combined (e.g., MME and S-GW).

### (Direction of Input and Output)

The information or the like (see the item of “Information and Signals”) can be output from a higher layer (or a lower layer) to a lower layer (or a higher layer). The information, the signals, and the like may be input and output through a plurality of network nodes.

### (Handling of Input and Output Information and the Like)

The input and output information and the like may be saved in a specific place (e.g., memory) or may be managed using a management table. The input and output information and the like can be overwritten, updated, or additionally written. The output information and the like may be deleted. The input information and the like may be transmitted to another apparatus.

### (Determination Method)

The determination may be made based on a value expressed by one bit (0 or 1), based on a Boolean value (true or false), or based on comparison with a numerical value (e.g., comparison with a predetermined value).

### (Software)

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

The software, the instruction, the information, and the like may be transmitted and received through a transmission medium. For example, when the software is transmitted from a website, a server, or another remote source by using at least one of a wired technique (e.g., a coaxial cable, an optical fiber cable, a twisted pair, and a digital subscriber line (DSL)) and a radio technique (e.g., an infrared ray and a microwave), the at least one of the wired technique and the radio technique is included in the definition of the transmission medium.

### (Information and Signals)

The information, the signals, and the like described in the present disclosure may be expressed by using any of various different techniques. For example, data, instructions, commands, information, signals, bits, symbols, chips, and the like that may be mentioned throughout the entire description may be expressed by one or an arbitrary combination of voltage, current, electromagnetic waves, magnetic fields, magnetic particles, optical fields, and photons.

Note that the terms described in the present disclosure and the terms necessary to understand the present disclosure may be replaced with terms with the same or similar meaning. For example, at least one of the channel and the symbol may be a signal (signaling). The signal may be a message. The component carrier (CC) may be called a carrier frequency, a cell, a frequency carrier, or the like.

### (“System” and “Network”)

The terms “system” and “network” used in the present disclosure can be interchangeably used.

### (Names of Parameters and Channels)

The information, the parameters, and the like described in the present disclosure may be expressed using absolute values, using values relative to predetermined values, or using other corresponding information. For example, radio resources may be indicated by indices.

The names used for the parameters are not limitative in any respect. Furthermore, the numerical formulas and the like using the parameters may be different from the ones explicitly disclosed in the present disclosure. Various channels (e.g., PUCCH and PDCCH) and information elements, can be identified by any suitable names, and various names assigned to these various channels and information elements are not limitative in any respect.

### (Base Station (Radio Base Station))

The terms “Base Station (BS),” “radio base station,” “fixed station,” “NodeB,” “eNodeB (eNB),” “gNodeB (gNB),” “access point,” “transmission point,” “reception point, “transmission/reception point,” “cell,” “sector,” “cell group,” “carrier,” “component carrier,” and the like may be used interchangeably in the present disclosure. The base station may be called a macro cell, a small cell, a femtocell, or a pico cell.

The base station can accommodate one cell or a plurality of (e.g., three) cells. When the base station accommodates a plurality of cells, the entire coverage area of the base station can be divided into a plurality of smaller areas, and each of the smaller areas can provide a communication service based on a base station subsystem (e.g., small base station for indoor remote radio head (RRH)). The term “cell” or “sector” denotes part or all of the coverage area of at least one of the base station and the base station subsystem that perform the communication service in the coverage.

### (Terminal)

The terms “Mobile Station (MS),” “user terminal,” “User Equipment (UE),” and “terminal” may be used interchangeably in the present disclosure.

The mobile station may be called, by those skilled in the art, a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or by some other appropriate terms.

### (Base Station/Mobile Station)

At least one of the base station and the mobile station may be called a transmission apparatus, a reception apparatus, a communication apparatus, or the like. Note that, at least one of the base station and the mobile station may be a device mounted in a mobile entity, the mobile entity itself, or the like. The mobile entity may be a vehicle (e.g., an automobile or an airplane), an unmanned mobile entity (e.g., a drone or an autonomous vehicle), or a robot (a manned-type or unmanned-type robot). Note that, at least one of the base station and the mobile station also includes an apparatus that does not necessarily move during communication operation. For example, at least one of the base station and the mobile station may be Internet-of-Things (IoT) equipment such as a sensor.

The base station in the present disclosure may also be replaced with the user terminal. For example, the aspects and the embodiments of the present disclosure may find application in a configuration that results from replacing communication between the base station and the user terminal with communication between multiple user terminals (such communication may, e.g., be referred to as device-to-device (D2D), vehicle-to-everything (V2X), or the like). In this case, terminal 10 may be configured to have the functions that base station 20 described above has. The wordings “uplink” and “downlink” may be replaced with a corresponding wording for inter-equipment communication (e.g., “side”). For example, an uplink channel, a downlink channel, and the like may be replaced with a side channel.

Similarly, the terminal in the present disclosure may be replaced with the base station. In this case, base station 20 is configured to have the functions that terminal 10 described above has.

### Meaning and Interpretation of Terms

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming,” “expecting,” “considering,” and the like.

The terms “connected” and “coupled” as well as any modifications of the terms mean any direct or indirect connection and coupling between two or more elements, and the terms can include cases in which one or more intermediate elements exist between two “connected” or “coupled” elements. The coupling or the connection between elements may be physical or logical coupling or connection or may be a combination of physical and logical coupling or connection. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like hat are non-limiting and non-inclusive examples.

### (Reference Signal)

The reference signal can also be abbreviated as an RS and may also be called as a pilot depending on the applied standard.

(Meaning of “Based on”)

The description “based on” used in the present disclosure does not mean “based only on,” unless otherwise specified. In other words, the description “based on” means both of “based only on” and “based at least on.”

### (“First” and “Second”)

Any reference to elements by using the terms “first,” “second,” and the like does not generally limit the quantities of or the order of these elements. The terms can be used as a convenient method of distinguishing between two or more elements in the present disclosure. Therefore, reference to first and second elements does not mean that only two elements can be employed, or that the first element has to precede the second element somehow.

### (Means)

The “section” in the configuration of each apparatus may be replaced with “means,” “circuit,” “device,” or the like.

### (Open Form)

In a case where terms “include,” “including,” and their modifications are used in the present disclosure, these terms are intended to be inclusive like the term “comprising.” Further, the term “or” used in the present disclosure is not intended to be an exclusive or.

(Time Unit such as TTI, Frequency Unit such as RB, and Radio Frame Configuration)

The radio frame may be constituted by one frame or a plurality of frames in the time domain. The one frame or each of the plurality of frames may be called a subframe in the time domain. The subframe may be further constituted by one slot or a plurality of slots in the time domain. The subframe may have a fixed time length (e.g., 1 ms) independent of numerology.

The numerology may be a communication parameter that is applied to at least one of transmission and reception of a certain signal or channel. The numerology, for example, indicates at least one of SubCarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in the frequency domain, specific windowing processing that is performed by the transmission and reception apparatus in the time domain, and the like.

The slot may be constituted by one symbol or a plurality of symbols (e.g., Orthogonal Frequency Division Multiplexing (OFDM)) symbol, Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be called by other corresponding names.

For example, one subframe, a plurality of continuous subframes, one slot, or one mini-slot may be called a Transmission Time Interval (TTI). That is, at least one of the subframe and the TTI may be a subframe (1 ms) in the existing LTE, a duration (e.g., 1 to 13 symbols) that is shorter than 1 ms, or a duration that is longer than 1 ms. Note that, a unit that represents the TTI may be referred to as a slot, a mini-slot, or the like instead of a subframe.

Here, the TTI, for example, refers to a minimum time unit for scheduling in radio communication. For example, in an LTE system, the base station performs scheduling for allocating a radio resource (a frequency bandwidth, a transmit power, and the like that are used in each user terminal) on a TTI-by-TTI basis to each user terminal. Note that, the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in a case where one slot or one mini-slot is referred to as the TTI, one or more TTIs (that is, one or more slots, or one or more mini-slots) may be a minimum time unit for the scheduling. Furthermore, the number of slots (the number of mini-slots) that make up the minimum time unit for the scheduling may be controlled.

A TTI that has a time length of 1 ms may be referred to as a usual TTI (a TTI in LTE Rel. 8 to LTE Rel. 12), a normal TTI, a long TTI, a usual subframe, a normal subframe, a long subframe, a slot, or the like. A TTI that is shorter than the usual TTI may be referred to as a shortened TTI, a short TTI, a partial TTI (or a fractional TTI), a shortened subframe, a short subframe, a mini-slot, a subslot, a slot, or the like.

Note that the long TTI (for example, the usual TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one symbol or a plurality of symbols in the time domain, and may have a length of one slot, one mini slot, one subframe, or one TTI. One TTI and one subframe may be constituted by one resource block or a plurality of resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. An UE may be configured with one or more BWPs within one carrier.

At least one of the configured BWPs may be active, and the UE does not have to assume transmission/reception of a predetermined signal or channel outside the active BWP. Note that, “cell,” “carrier,” and the like in the present disclosure may be replaced with “BWP.”

Structures of the radio frame, the subframe, the slot, the mini-slot, the symbol, and the like are described merely as examples. For example, the configuration such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

In a case where articles, such as “a,” “an,” and “the” in English, for example, are added in the present disclosure by translation, nouns following these articles may have the same meaning as used in the plural.

In the present disclosure, the expression “A and B are different” may mean that “A and B are different from each other.” Note that, the expression may also mean that “A and B are different from C.” The expressions “separated” and “coupled” may also be interpreted in the same manner as the expression “A and B are different.”

### (Variations and the Like of Aspects)

The aspects and embodiments described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

### INDUSTRIAL APPLICABILITY

One aspect of the present disclosure is useful for mobile communication systems.

### REFERENCE SIGNS LIST

10 UE (Terminal)
20 gNB (Base station)
30A-4, 30B-4 NEF (Network Exposure Function)
510, 610, 710 Transmission section
520, 620, 720 Reception section
530, 630, 730 Configuration section
540, 640, 740 Control section

1. A network node, comprising:
a reception section that receives, from a first user, an authorization request for invocation of an Application Programming Interface (API) which requires authorization from a second user;
a control section that identifies the second user based on the authorization request; and
a transmission section that transmits, to the second user, information indicating that the authorization request has been received from the first user.

2. The network node according to claim 1, wherein:
the reception section receives, from the second user, information indicating that the authorization has been made for the invocation of the API of the first user;
the control section issues an access token, based on the authorization of the second user; and
the transmission section transmits the access token to the first user.

3. A user node, comprising:
a transmission section that transmits, to a network node, an authorization request for invocation of an Application Programming Interface (API) which requires authorization from another user;
a reception section that receives, from the network node, information and an access token, the information indicating that the authorization has been made by the other user; and
a control section that invokes, using the access token, the API which requires the authorization from the other user.

4. A user node owned by a resource holder, the user node comprising:
a reception section that receives, from a network node, information indicating that an authorization request for invocation of an Application Programming Interface (API) has been received from another user;
a control section that verifies the authorization request and authorizes the other user; and
a transmission section that transmits, to the network node, information indicating that the invocation of the API of the other user is authorized.

5. A communication method, comprising:
indicating to a network node, by a first user, an authorization request for invocation of an Application Programming Interface (API) which requires authorization from a second user;
identifying, by the network node, the second user based on the authorization request;
transmitting to the second user, by the network node, information indicating that the authorization request has been received from the first user;
verifying, by the second user, the authorization request and authorizing, by the second user, the first user;
transmitting to the network node, by the second user, information indicating that the authorization has been made for the invocation of the API of the first user;
issuing an access token, by the network node, based on the authorization of the second user;
transmitting the access token to the first user, by the network node; and
invoking, by the first user using the access token, the API which requires the authorization from the second user.
